(19) United States
(12) Patent Application Publication
(10) Pub. No.: US 2026/0176110 A1
(43) Pub. Date: Jun. 25, 2026

(54) POWER SUPPLY FOR CRANE SYSTEMS

(71) Applicant: WIKA Alexander Wiegand SE & Co. KG, Klingenberg/Main (DE)

(72) Inventors: Zivorad GOLUBOVIC, Karlsruhe (DE); Martin WEIS, Karlsruhe (DE)

(73) Assignee: WIKA Alexander Wiegand SE & Co. KG, Klingenberg/Main (DE)

(21) Appl. No.: 19/380,250

(22) Filed: Nov. 5, 2025

(30) Foreign Application Priority Data
Nov. 8, 2024 (DE) 10 2024 132 677.8

(51) Int. Cl. B66C 13/14; B66C 13/30

(52) U.S. Cl. CPC B66C 13/14; B66C 13/30

(57) ABSTRACT

A power supply for crane systems is provided. In order to transmit greater power at or before a rope length transmitter, the voltage is transformed up in a first converter and transformed back again in a second converter at the end of a cable, at or near a tip of the crane, for the consumers.

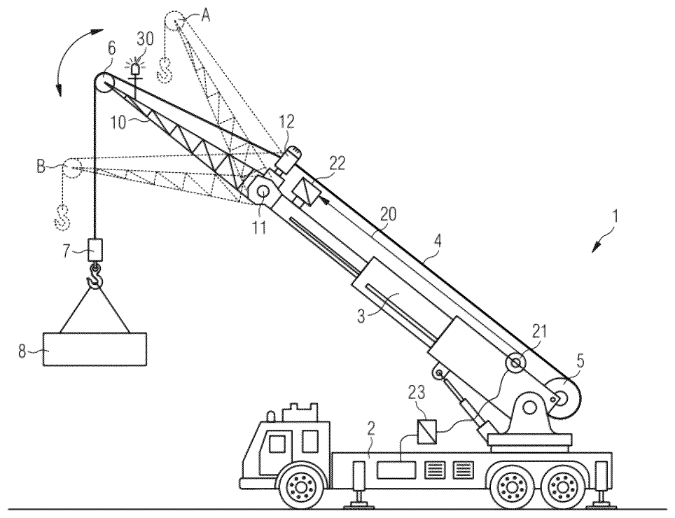

This nonprovisional application claims priority under 35 U.S.C. § 119(a) to German Patent Application No. 10 2024 132 677.8, which was filed in Germany on Nov. 8, 2024, and which is herein incorporated by reference.

### BACKGROUND OF THE INVENTION

### Field of the Invention

The invention relates to a power supply for crane systems with a voltage transformer, to a method for supplying power to a crane system, and to a method for starting up a crane system. The invention relates in particular to a power supply for crane systems, a so-called “high power cable reel.”

### Description of the Background Art

Mobile cranes are known from the conventional art having a flexible cable which, wound onto a reel, supplies crane parts with on-board voltage, even if the crane parts move relative to each other and thus change their relative length, or if the crane parts move. A power transmission limit results from the cable cross sections used and the known law according to which the transmittable electrical power corresponds to the product of the voltage and the current (P=U×I).

German utility model DE 20 2013 010 381 U1, which corresponds to US 2015/0128735, is directed to a drive for a sliding connecting member of a locking system of a telescopic system.

Further, DE 10 2016 007 053 A1 discloses a mobile crane with a telescopic boom and luffing jib. A power supply for the luffing jib can be provided by the mobile crane via a variable-length supply line, wherein the supply line is taken up by a reel mounted on the telescopic boom.

Furthermore, WO 2012/133657 A1 discloses a crane device with a PWM converter. The PWM converter switches the alternating current, fed from a busbar by a PWM control, to convert the alternating current into direct current such that the phase difference between a voltage and a current of the alternating current is reduced.

In addition, WO 93/18566 A1 discloses a method for economically transmitting low-power electrical energy over large distances, wherein this energy is transmitted with a single phase by means of a transmission voltage having a low, different from zero transmission frequency.

Lastly, DE 10 2016 009 987 A1 describes a method for supplying power in a power distribution system in the low voltage range below 25 volts AC or 60 volts DC, in which at least one power supply and two or more voltage converters are used to supply at least two possible power consumers. Further, a corresponding power distribution system and the associated device are disclosed.

A disadvantage of the systems known from the state of the art can at times be that only a limited voltage is available to supply the consumers when using the on-board power supply of a mobile crane. Power losses can also be perceived as a disadvantage, which can hardly be avoided with the long cable distances to be bridged.

### SUMMARY OF THE INVENTION

It is therefore an object of the present invention to provide a power supply for consumers on mobile cranes with particularly high power requirements over long distances. Moreover, a structure for the flexible electrical supply of a crane section with a change in location is to be created.

In an example, a power supply for a crane system is provided that comprises a mobile crane with a chassis on which a telescopic boom is mounted, over which a suspension rope is guided. The suspension rope can be wound up in a reel at a first rope end. Further, the suspension rope is guided over a tip of the boom and provided at a second rope end with a hook, with which loads can be lifted.

At least one consumer is arranged, in particular attached, at or near the tip of

the boom. In particular, the at least one consumer can be an electrical consumer, for example, a lamp, a winch, and/or a drive. To supply power to the at least one consumer, which is provided via the on-board power supply or a power supply for the crane system, a cable, which can be wound up in a rope length transmitter, is guided along the telescopic boom.

The telescopic boom can, for example, comprise a plurality of telescopic steps and each step can be designed as a square hollow profile or hollow box profile. The suspension rope and the cable of the rope length transmitter can be guided along the telescopic boom in its longitudinal direction. The suspension rope and the cable of the rope length transmitter can be guided along the outside of the boom. In a particularly advantageous embodiment, it can be provided that the suspension rope and/or the cable of the rope length transmitter is also guided inside the hollow profile of the boom. In this way, the suspension rope and especially the cable of the rope length transmitter can be effectively protected against damage, dirt, or the like.

A first function of the rope length transmitter can be, for example, to determine the length of the boom. A reel for winding the cable can be provided in the housing of the rope length transmitter. A cable length in a dimension of at least the maximum length of the boom can be wound onto the reel. If attachments are provided to extend the boom length, a correspondingly longer cable length can be kept in stock. Further, a mechanism for tightening the cable can also be integrated into the housing of the rope length transmitter.

A second function of the rope length transmitter can be the transmission of electrical power to the tip of the boom. In this respect, the rope length transmitter, which is already required to determine the boom length, is also used to be able to transmit electrical energy between the crane system and the consumer or the multiple consumers at the tip of the boom.

In order to transmit electrical power, an electrical voltage can be transformed to a first voltage value in a first converter at or before the rope length transmitter. Further, the electrical voltage at the end of the cable, at or near the tip of the boom, can be transformed to a second voltage value in a second converter to supply voltage to the consumer, wherein the first voltage value is higher than the second voltage value.

In other words, the power supply for crane systems has a voltage converter unit that can transmit higher power with low losses by means of voltage conversion, similar to overhead power lines. Standard cable cross sections can be used in this regard. Together with a cable winding system, in particular the rope length transmitter, locationally displaceable consumers on a crane can thereby also be supplied with higher energy than was previously practical or could only be realized by using large cable cross sections. The term “locationally displaceable” can be understood to mean, for example, a change in a length of the telescopic boom of the mobile crane. In the case of particularly large mobile cranes with telescopic booms, boom lengths of well over 100 m (meters) can be achieved, for which the application of the invention is particularly suitable.

At or near the tip of the crane or at the end of the cable, the voltage may then be converted back to the usual voltage level so that usual components can be used, which, however, may have a higher power requirement. In particular, the voltage conversion makes it possible to transmit higher power through existing, known, or small cable cross sections, especially also for stranded winding cables from the state of the art. Furthermore, more power transmission is also possible with existing cables by retrofitting to cranes.

For example, a consumer at the tip of the boom can be an electric actuator with a wattage of 240 W (watts) or a multiple thereof. On the one hand, higher electrical power can be provided at the tip of the boom by the double transformation. “Higher” electrical power can be understood to mean a power of multiple hundred watts in particular. On the other hand, power losses occurring with longer cable lengths of more than 100 m can be effectively reduced.

The first voltage value can correspond to a multiple, in particular double, of

the second voltage value. A voltage before the first converter can be, for example, an on-board voltage of a truck and constitute 12 V (volts), for example. The on-board voltage of the truck can be increased to the first voltage value of, for example, 24 V or 48 V. At the second converter, the voltage value of 24 V or 48 V can be reduced to the second voltage value, namely, 12 V. For example, the on-board voltage can correspond to the second voltage value in amount.

A voltage before the first converter can be, for example, a frequently used on-board voltage of a truck of, for example, 24 V (volts). This on-board voltage of the truck can be increased, for example, from 24 V to the first voltage value of, for example, 48 V or 96 V. At the second converter, the voltage value of 48 V or 96 V can be reduced to the second voltage value, namely, 24 V. In this case, the on-board voltage can again correspond to the second voltage value in amount.

The first and/or second converter can be a DC-to-DC converter and provides an electrical current of 30 A (amperes), 60 A, or 80 A. For example, a 1.5-2.5 kN (kilonewton) linear drive or another gearbox or consumer can be driven with up to 2000 W thereby. The first converter can be a so-called step-up converter, for example. The second converter can be a step-down converter, for example. In particular, a DC-to-DC direct voltage conversion can be carried out with both converters.

The electrical voltage can be transformed as a direct or alternating voltage from a voltage value of 12 V or 24 V to a voltage value of 48 V or 48 +/−5 V. For example, the transformation from 12 V to 48 V can take place via the first converter, the step-up converter. In this case, a current of around 20 A can flow. A transformation from 48 V to 12 V can take place at the second converter, the step-down converter. An output current can be 60 A or more, for example.

Furthermore, a so-called power switch module, which controls the transformation, can be provided upstream of the first converter. A further control device can be provided downstream of the second converter and upstream of the consumer. If an electric motor is to be supplied with electricity, a motor control device can be connected in between.

A movable articulated arm can be mounted at the end of the boom, near the tip, which arm can be tilted and/or luffed in two or between two positions by an electric drive, preferably an electric motor with a gearbox.

The articulated arm, for example, can be tilted in relation to the longitudinal direction of the boom, which significantly increases the reach of the mobile crane compared to a simple variant without an articulated arm. Such articulated arms were controlled hydraulically until now. Replacing the hydraulic drive with an electric motor was not possible with previous technical solutions, because the required power could not be achieved in the crane tip. An electrical power of 240 W or up to 960 W in the tips, for example, can now be achieved by the present invention. Thus, a particularly powerful electric drive can be installed, which can reliably swivel or luff the articulated arm even under suspended load.

It can also be provided that further consumers, for example, lamps, winches, spotlights, movable spotlights, cameras, movable cameras, force sensors, pressure sensors, linear actuators, or other winch motors, can be arranged on the movable articulated arm and are supplied with energy or controlled. In particular, the uses of particularly powerful spotlights at the tip of the mobile crane for illuminating construction sites can be made possible by the invention. The suspended load can be determined in real time using force sensors, which can be arranged in the bearings of the articulated arm, for example.

The cable can comprise at least two cores which are electrically insulated from one another. The cores can have a cross section or cross-sectional area in the range of 0.2 mm² (square millimeters) and 1.5 mm², in particular 0.5 mm². For example, at least two cores can be provided for the power supply to the consumer. The cable can extend over a length of at least 50 m (meters), in particular in a range of 50 m to 200 m.

At least one additional core can be provided for data transmission of the consumer's measurement data. In the case of an electric motor as a consumer, for example, the power consumption or temperature of the motor can be detected and transmitted via the core or data cable. Further, sensors for determining the wind speed or an angle of the articulated arm relative to the longitudinal axis of the boom can also be determined and transmitted to a display in the driver's cab of the mobile crane via the core provided for this purpose.

A method for supplying energy to a crane system comprises a mobile crane with a chassis on which a telescopic boom is mounted, over which a suspension rope is guided, which can be wound up in a reel at a first rope end. The suspension rope is guided over a tip of the boom and is provided at a second rope end with a hook, which can be used to lift loads.

At least one consumer, for example, a lamp, a winch, and/or a drive, can be attached to or near the tip of the boom. To supply power to the at least one consumer, a cable, which can be wound up in a rope length transmitter, may be guided along the boom.

An electrical voltage can be transformed to a first voltage value in a first converter at or before the rope length transmitter in order to transmit electrical power. Further, the electrical voltage at the end of the cable, at or near the tip of the boom, can be transformed to a second voltage value in a second converter to supply voltage to the consumer. In this case, the first voltage value is higher than the second voltage value.

For example, the cable can be electrically contacted via a slip ring on the rope length transmitter. The voltage is then converted back to the usual voltage level at or near the tip of the crane or at the end of the cable. For example, a consumer at the tip of the boom can be an electric actuator with a wattage of 240 W or a multiple thereof. On the one hand, higher electrical power can be provided at the tip of the boom by the double voltage conversion and transformation. On the other hand, power losses, which occur in particular with longer cable lengths of more than 100 m, can be effectively reduced.

The first voltage value may correspond to a multiple, in particular double, of the second voltage value. A voltage before the first converter can be, for example, an on-board voltage of a truck and constitute 12 V, for example. The on-board voltage of the truck can be increased to the first voltage value of, for example, 24 V or 48 V. At the second converter, the voltage value of 24 V or 48 V can be reduced to the second voltage value, namely, 12 V. For example, the on-board voltage can correspond to the second voltage value in amount. Either alternating voltage (AC) or direct voltage (DC) can be provided.

The first and/or second converter can be a DC-to-DC converter by which an electric current of 30 A, 60 A, or 80 A is provided.

For example, the transformation from 12 V to 48 V can take place via the first converter, a so-called step-up converter. In this case, a current of around 20 A can flow. A transformation from 48 V to 12 V can take place at the second converter, a so-called step-down converter. As a result, a maximum power of 960 W can be achieved, for example. A corresponding electronic control system at the crane tip allows the high powers to be regulated as required.

A pulse width modulation can be carried out for voltage conversion and/or transformation. The pulse width modulation can, for example, be controlled by a control unit depending on the power requirement of the consumer at the crane tip.

A short circuit in the cable or a short to ground or a resistance deviation to the crane or boom can be monitored via a monitoring unit and, upon detection, an alarm or a shutdown unit may be activated. The electrical consumer(s) at the crane tip and other sensitive electrical devices on the crane can be protected thereby from overload. For this purpose, for example, standard values can be stored in a table and compared with real-time measured values. In the event of a deviation above a preset threshold value, previously defined electrical consumers of the mobile crane can be switched off.

A method for starting up a crane system can have a power supply as described above. Attachments, such as an articulated arm, and/or electrical consumers can be attached or connected to the mobile crane. As part of a security check, for example, a device calibration or a cyber security check, all consumers or attachments can be checked. The data from the attachments and/or consumers can be transmitted in particular in a digital and/or encrypted data format via specially provided cores of the cable.

Test codes for the attachments and/or consumers can be stored in an internal crane library and can be compared during the check. In particular, all connected consumers or attachments can be queried in sequence at each start-up and compared with the stored test codes in a central control system. Only after a successful check are the consumers and/or attachments provided with the actual load current via corresponding cable strands or only then enabled for use. In particular, the cable can consist of one or more power strands. Further, one or more relays can be connected in between in addition.

In particular, manipulations by third parties can also be uncovered in a cyber security check. The maximum load capacity of a crane can be exceeded via attachments with manipulated firmware. This makes it all the more important to ensure that the connected attachments or consumers are specially designed for this purpose.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole figure shows a schematic illustration of a mobile crane.

### DETAILED DESCRIPTION

The figure shows a mobile crane 1 with a chassis 2 on which an extendable boom 3 is mounted. A suspension rope 4 is guided over boom 3 and can be wound up in a reel 5. Suspension rope 5 is guided over a tip 6 and provided at the end with a hook 7, with which loads 8 can be lifted.

A movable articulated arm 10 is mounted at the end of boom 3, which arm can be tilted or luffed between two positions A and B by an electric drive 12, preferably a motor with a gearbox. The movable articulated arm 10 can carry further consumers 30, such as, e.g., lamps, winches, servomotors, or the like.

In particular, articulated arm 10 can be tilted relative to a longitudinal direction of boom 3, which significantly increases the reach of mobile crane 1 compared to a simple variant without an articulated arm. To swivel articulated arm 10, for example, a particularly powerful electric drive can be installed, which can reliably swivel or luff articulated arm 10 even with a suspended load 8.

To supply these electrical consumers 30 or drive 12 at or near tip 6 of mobile crane 1, a windable cable 20 with one or more cores is guided on the boom, which cable is wound on a reel of a rope length transmitter 21.

A first function of rope length transmitter 21 can be, for example, to determine the length of boom 3. A reel for winding the cable can be provided in the housing of rope length transmitter 21. A cable length in a dimension of at least the maximum length of the boom can be wound onto the reel. If attachments are provided to extend the boom length, such as, for example, articulated arm 10, a correspondingly longer cable length can be kept in stock. Further, a mechanism for tightening the cable can be integrated into the housing of rope length transmitter 21.

A second function of rope length transmitter 21 for the purpose of the invention is the transmission of electrical power to tip 6 of boom 3. In this respect, the rope length transmitter, which is already required to determine the boom length, is used in addition to be able to transmit electrical energy between the crane system and consumer 30 or the multiple consumers at tip 6 of boom 3.

For the transmission of higher electrical power, for example, in a range from 240 watts to 2000 watts, in particular 960 watts, the voltage is transformed up in a first converter 23 at or before rope length transmitter 21 and transformed back again in a second converter 22 at the end of cable 20, at or near tip 6, for consumers 30.

For example, the power supply for crane systems can in addition transform, for example, a DC or AC voltage from 12 V or 24 V to 48 V or 48 V +/−5 V (volts) or any other voltage. The power supply is equipped here in such a way that, e.g., cable 20 has multiple cores, each with a cross section of 0.5 mm² (square millimeters), for example. For example, cable 20 can comprise three cores with a cross-sectional area of 0.5 mm² (square millimeters) each. The cores can, for example, be formed as strands or comprise multiple strands. The power supply, and in particular first converter 23, are designed so that it can provide 30, 60, or 80 A, for example, to drive a 1.5-2.5 kN (kilonewton) linear drive or another gearbox or consumer with up to 2000 watts.

First converter 23 can be a so-called step-up converter, for example. Second converter 22 can be a step-down converter, for example. In particular, a DC-to-DC direct voltage conversion can be performed with both converters 22, 23. For example, the transformation from 12 V to 48 V can take place via first converter 23, the step-up converter. For example, in so doing a current of around 20 A can flow. A transformation from 48 V to 12 V can take place at second converter 22, the step-down converter. An output current can be 60 A or more, for example.

Furthermore, a so-called power switch module, which controls the transformation, can be provided upstream of first converter 23. A further control device can be provided downstream of second converter 22 and upstream of consumer 30. If an electric motor is to be supplied with power, a motor control device can also be connected in between.

The new power supply for crane systems can have further consumers 30 such as, e.g., lamps, winches, spotlights, movable spotlights, cameras, movable cameras, force sensors, pressure sensors, or other winch motors, or linear actuators connected to the movable articulated arm 10 or potentially supply or control them in an attachable manner, wherein the energy distribution is monitored via a controller with regard to load peaks and an overload is monitored via current monitoring or temperature measurement, and a warning is given to the crane operator in good time if the load is too high.

The power supply for crane systems can also have a monitoring unit which monitors a short circuit in cable 20 or a short to ground or a resistance deviation to the crane or boom and upon detection, activates an alarm or a shutdown unit.

As part of a security check, for example, a device calibration or a cyber security check, all consumers 30 or attachments can be checked. In this case, the data of the attachments and/or consumers 30 can be transmitted in particular in a digital and/or encrypted data format via specially provided cores of cable 30.

In a particularly secure version, the power supply or the control unit assigned for this purpose recognizes via cable 20 or in parallel by radio whether all parts are permissible for the respective configuration and have previously been stored for this mobile crane 1. For this purpose, attachments or sensors or components are queried in sequence via cable 20 at boom 3 at each start-up as part of a cyber security check, wherein all components are digitally compared with a test code stored in the central control system, and only after a successful check are the components on the power strands provided with the actual load current via relays, or only then enabled for use.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A power supply for crane systems comprising a mobile crane with a chassis on which a telescopic boom is mounted, over which a suspension rope is guided that is adapted to be wound up in a reel at a first rope end, the suspension rope being guided over a tip of the boom and is provided at a second rope end with a hook, with which loads are adapted to be lifted, wherein at least one consumer is attached to or near the tip of the boom, wherein, to supply power to the at least one consumer a cable, which is adapted to be wound up in a rope length transmitter, is guided along the boom, the power supply comprising:
a first converter to transmit electrical power, the first converter transforming an electrical voltage to a first voltage value at or before the rope length transmitter; and
a second converter to transform the electrical voltage at the end of the cable at or near the tip of the boom to a second voltage value to supply voltage to the consumer,
wherein the first voltage value is higher than the second voltage value.

2. The power supply for crane systems according to claim 1, wherein the first voltage value corresponds to a multiple or double, of the second voltage value.

3. The power supply for crane systems according to claim 1, wherein the first and/or second converter is a DC-to-DC converter and provides an electric current of 30 A, 60 A, or 80 A.

4. The power supply for crane systems according to claim 1, wherein the cable comprises at least two cores which are electrically insulated from one another, wherein the cores each have a cross-sectional area of 0.2 mm² to 1.5 mm² or 0.5 mm², and extend over a length of at least 50 m.

5. The power supply for crane systems according to claim 1, wherein the electrical voltage is transformed as a direct or alternating voltage from a voltage value of 12 V or 24 V to a voltage value of 48 V or 48 V +/−5 V.

6. The power supply for crane systems according to claim 1, wherein a movable articulated arm is mounted at the end of the boom, near the tip, which arm is adapted to be tilted and/or luffed in two or between two positions (A) or (B) by an electric drive, preferably a motor with a gearbox.

7. The power supply for crane systems according to claim 1, wherein further consumers comprising lamps, winches, spotlights, movable spotlights, cameras, movable cameras, force sensors, pressure sensors, linear actuators, or other winch motors, are arranged on the movable articulated arm and are supplied with energy or controlled.

8. The power supply for crane systems according to claim 1, wherein the cable has a plurality of cores insulated from one another, wherein at least two cores thereof are provided for the power supply to the consumer, wherein at least one additional core is provided for data transmission of the consumer's measurement data.

9. A method for supplying power to a crane system comprising a mobile crane with a chassis on which a telescopic boom is mounted, over which a suspension rope is guided that is adapted to be wound up in a reel at a first rope end, the method comprising:
guiding the suspension rope over a tip of the boom, wherein a hook is provided at a second rope, with which loads are adapted to be lifted;
attaching at least one consumer, which comprises a lamp, a winch, and/or a drive, to or near the tip of the boom;
guiding a cable, which is adapted to be wound up in a rope length transmitter, along the boom to supply power to the at least one consumer;
transforming, in order to transmit electrical power, an electrical voltage to a first voltage value in a first converter at or before the rope length transmitter; and
transforming the electrical voltage at the end of the cable, at or near the tip of the boom, to a second voltage value in a second converter to supply voltage to the at least one consumer,
wherein the first voltage value is higher than the second voltage value.

10. The method for supplying power to a crane system according to claim 9, wherein the first voltage value corresponds to a multiple or double, of the second voltage value.

11. The method for supplying power to a crane system according to claim 9, wherein the electrical voltage is transformed as a direct or alternating voltage from a voltage value of 12 V or 24 V to a voltage value of 48 V or 48 V +/−5 V.

12. The method for supplying power to a crane system according to claim 9, wherein the first and/or second converter is a DC-to-DC converter by which an electric current of 30 A, 60 A, or 80 A is provided.

13. The method for supplying power to a crane system according to claim 9, wherein a pulse width modulation is carried out for voltage conversion and/or transformation.

14. The method for supplying power to a crane system according to claim 9, wherein a short circuit in the cable or a short to ground or a resistance deviation to the mobile crane or boom is monitored via a monitoring unit and upon detection, an alarm or a shutdown unit is activated.

15. A method for starting up a crane system with a power supply according to claim 1, the method comprising:
querying connected consumers or attachments in sequence via the cable at the boom at each start-up as part of a cyber security check;
digitally comparing the consumers or attachments with a test code stored in a central control system; and
providing, only after a successful cyber security check, the consumers or attachments with the actual load current via the cable, or only then enabling use.

16. The power supply according to claim 1, wherein the at least one consumer comprises a lamp, a winch, and/or a drive.
